(19) United States
(12) Patent Application Publication
(10) Pub. No.: US 2011/0042235 A1
(43) Pub. Date: Feb. 24, 2011

(54) Process and Equipment for the Oxidation of Organic Matter

(76) Inventors: Alain Bergel, Toulouse (FR); Luc Etcheverry, Montlaur (FR); Benjamin Erable, Arvert (FR)

Correspondence Address: STITES & HARBISON PLLC, 1199 NORTH FAIRFAX STREET, SUITE 900, ALEXANDRIA, VA, 22314, US

(21) Appl. No.: 12/866,556

(22) PCT Filed: Feb. 11, 2009
(86) PCT No.: PCT/FR09/50216

§ 371 Date: Nov. 8, 2010

(30) Foreign Application Priority Data
Feb. 11, 2008 (FR) 08 50833

(51) Int. Cl. C02F 1/461; C02F 1/46

(52) U.S. Cl. 205/745; 206/223

(57) ABSTRACT

The present invention relates to an oxidation process for organic matter and the kit for carrying out said process, in particular for the treatment of waste, effluent and sewage sludge.

Waste production in France exceeds 600 million tonnes per year. Over two thirds is organic waste with the following origins:
agricultural waste, such as animal faeces, waste from cultivation and forestry: 84% of the total quantity of organic waste;
waste from the agro-food industry: 10%;
local authority waste, such as sludge from sewage treatment plants, septic tank sludge, green spaces, markets, street cleaning: 5%;
household waste, such as refuse bins: 1%.

In France, 95% of towns with over 10,000 inhabitant equivalents have a sewage treatment plant and the production of sewage sludge is constantly increasing. Nowadays, almost all sewage treatment plants include biological treatment during which microorganisms decompose the organic, nitrogenous and phosphorus-containing matter which forms the pollutant load of the wastewater. Urban effluent is usually channeled to a basin where these organisms proliferate in the form of activated sludge. This sludge consumes oxygen in order to act and steps must therefore be taken to ensure that it is suitably aerated. Aeration accounts for 60% to 80% of the energy expended by this type of sewage treatment plant which is the equivalent of a consumption of about 50 kWh per year per inhabitant equivalent. It is generally accepted that optimising this item of expenditure should produce savings of approximately 10% to 20% of the total operating cost of the plant.

At the same time, in sewage treatment plants for urban effluent, the present trend is to have mini treatment stations at the outlet of facilities producing specific effluents, for example the treatment of oil loads as they leave mechanical production workshops, the treatment of liquid manure or dairy effluent as it leaves stock-rearing units or agro-food processing centres, the detoxification of hospital waste, and so on. New requirements are also arising such as the biological treatment of water from swimming pools or the domestic composting of food waste.

In all cases, improving organic matter oxidation by microorganisms and oxygen is desirable.

Microorganisms adhere spontaneously to all types of surface and form films known as biofilms made up of said microorganisms, a matrix of exopolymeric substances (such as polysaccharides, proteins or macromolecules) which they excrete, substances produced by microbial metabolism and accumulated compounds originating in the medium or produced by degradation of the support surface. It was discovered recently that biofilms that have developed on conductive surfaces are capable of using these surfaces to carry away the electrons produced by their metabolism (D. R. Bond et al., Science 295 (2002) 483, and L. M. Tender et al. Nature Biotechnology 20 (2002) 821; H. J. Kim et al., Enzyme and Microbial Technology 30 (2002) 145). The mechanisms are still not fully understood and several reactive pathways occur depending on the type of microorganism making up the biofilms (K. Rabaey et al., Trends in Biotechnology 23 (2005) 291; D. R. Lovley, Current Opinion in Biotechnology 17 (2006) 1). In some cases, the microorganisms produce small redox compounds which act as electrochemical mediators between the microbial cells and the surface—these compounds are reduced by the microorganism and are oxidised as they return to the surface. Other microorganisms have been shown to be capable of directly transferring the electrons produced by their metabolic oxidation to a conductive surface due to redox compounds contained in their outer membrane. Some microorganisms form conductive pili to attach themselves electrochemically to surfaces or other microorganisms. Whatever the reactive pathways, biofilms have proved capable of oxidising organic matter by directly transferring electrons to a conductive surface.

Other biofilms have been shown to be capable of catalysing oxygen reduction on materials such as stainless steel (A. Berge) et al., Electrochemistry Communications, 2005, 7, 900-904; FR 02 10009) which, in their initial state with no biofilm, are not known to produce high oxygen reduction speeds. These biofilms may be put to good use on the surface intended to carry the electrons from the system to a dissolved compound, such as oxygen.

Whether they are capable of catalysing electrochemical oxidation or reduction reactions, in the rest of this document these biofilms will be referred to as electrochemically active or EA biofilms.

However, this technology is used basically for cells, in other words to produce electricity. This requires the installation of a complex electric circuit, which is not particularly compatible with installations such as waste treatment units. Moreover, such cells do not produce enough electricity at present to make their implementation at waste facilities attractive.

On the other hand, waste facilities are faced with the high electricity consumption required to supply the aeration tanks. Designing systems that reduce or even eliminate the need to aerate the waste or effluent to be treated is therefore desirable. Indeed, it is known that aeration of the media to be treated is necessary for the microorganisms to grow and thus consume the organic matter. Respiration involves carrying away the electrons produced by the organic matter microbial oxidation process to an external electron acceptor, usually oxygen dissolved in the medium, which is thus reduced to water. Some microorganisms are capable of respiring by reducing other electron acceptors such as nitrates, nitrites or sulphates. The lack of an electron acceptor in the medium, oxygen in this particular case, considerably reduces, or even completely destroys, the ability of the microorganisms to oxidise organic matter.

It is therefore particularly desirable to provide a process for limiting and even eliminating the use of aeration tanks.

The present invention proposes to grow microorganisms on conductive surfaces which are suitable for collecting the electrons produced by organic matter metabolic oxidation processes. In this way, the conductive surfaces on which the microorganisms grow extract the electrons.

To remove the electrons, the surface supporting the microorganisms which oxidise the organic matter must be connected to a surface that carries them to a final acceptor, such as oxygen. Thus, the two surfaces—the one that collects the electrons produced by the microorganisms which oxidise the organic matter and the one that carries the electrons to the final electron acceptor, such as oxygen—allow the microorganisms to “breathe”. The same principle may be used with nitrates, nitrites, sulphates, thiosulphates or any other dissolved or gaseous compound which can be reduced.

With its first subject-matter, the present invention relates to a process for the oxidation of organic matter comprising the application of a system to said organic matter to be treated comprising
a first portion (1) made of conductive material,
a second portion (2) made of conductive material, said process comprising simultaneously:
putting the first portion (1) in contact with said organic matter and one or more microorganism(s) capable of forming an EA biofilm (4) on the surface of said first portion,
putting said second portion in contact with an electron acceptor in the presence of a catalyst (5) and/or one or more microorganism(s) capable of forming an EA biofilm (5′) on the surface of said second portion, and
putting said first and second portions in electric contact via a short circuit.

Organic matter is understood to be any matter that can be oxidised. In particular, agricultural waste, such as animal faeces, waste from cultivation and forestry; waste from the agro-food processing industry; local authority waste, such as sludge from sewage treatment plants, septic tank sludge, green spaces, markets, street cleaning; and household waste, such as refuse bins, and so on.

According to a first embodiment, the system according to the invention may thus be formed of a single electrically conductive component, such as an electrically conductive bar of which one end forms the first portion and the other end the second portion.

According to another embodiment, the system according to the invention may also be formed of two separate components put in electric contact by a conductor with the lowest possible resistance, in particular substantially zero, and in any event less than 10 ohms. The two components may be formed of the same conductive material or two different conductive materials; they may be integral or connected to one another by a simple conductive component.

Thus, when treating effluent in an anoxic reactor, said system may comprise a first portion made of graphite, immersed in the anaerobic layers of the reactor, this portion being connected by a conductor to a second portion made of stainless steel or any type of material that can catalyse the reduction of the oxygen in the upper aerated portion of the reactor. To produce the reductive zone of the system according to the invention, any type of cathode known in the prior art may be used, such as air cathodes in order to carry the electrons to the gaseous oxygen. The second portion may comprise a deposited catalyst such as platinum and/or an EA biofilm, formed for example by the method described in patent application FR 0210009, to catalyse the reduction reaction.

According to another embodiment, the system according to the invention may use conductive portions of the reactor, simply by producing a short circuit between said portions. A system according to the invention may be formed for example by connecting the walls or lining of a waste or effluent treatment reactor via an electrical conductor of substantially zero resistance to an internal aeration module. In this case, the walls or lining would form the oxidising portion of the system according to the invention, while the aeration module, made of a conductive material such as steel, forms the reductive portion.

According to the invention, the first and second portions have the same electrochemical potential.

Advantageously, said first and second portions are submerged in a single reactor containing said organic matter to be treated, said microorganisms capable of forming an EA film and the electron acceptor, said reactor comprising no separating component, such as a membrane, between said first and second portions.

The electron acceptor may be chosen from any substance that can be reduced. It may be selected advantageously from oxygen, nitrates, nitrites, sulphates or thiosulphate, but most preferably oxygen.

Particularly when oxygen is used, reduction of the electron acceptor may occur spontaneously on particular materials such as graphite or steel. However, it may be advantageous to use as a reduction catalyst of said electron acceptor either a known compound deposited on its surface or a microbial biofilm, or a combination of the two. Said catalyst is chosen from any substance capable of catalysing the reduction reaction. In particular, it may be a metal such as platinum or a platinum-, nickel-, or silver-based compound. These compounds are deposited on the surface of the second portion by any method known to the person skilled in the art, such as electrochemical deposition, chemical vapour deposition, sol gel deposition, trapping in polymer films, paints, inks and so on. Catalysis may also take place via a biofilm consisting of microorganisms capable of forming an effective EA biofilm for said electron acceptor. In this case, the microbial film may form spontaneously on the surface of the second portion, or a pre-treatment may cause, initiate or accelerate its formation, for example as described in patent FR0210009.

Said microorganism(s), which form an EA biofilm (4, 5′) on the surface of the first portion and possibly the second portion of the system according to the invention, usually exist spontaneously in the reactive mixture to be treated. Alternatively or cumulatively, consideration may be given to seeding the reactive mixture to be treated with suitable microorganism(s) in any of the possible forms, including inocula, culture media or lyophilisates. Samples of media known to contain microorganisms that easily form EA biofilms, such as aqueous effluent sludge from sewage treatment plants, marine sediments or biofilms, composts or any other medium known by the person skilled in the art to produce EA biofilms may be used as inoculum for this purpose. It may be advantageous to seed using samples of EA biofilms which have previously collected on the anodes (for the first portion) or cathodes (for the second portion) of any system that uses EA biofilms, such as the present device or microbial fuel cells. Indeed EA biofilms are known to make good inocula to reform EA biofilms. The first subcultures often produce a significant increase in catalytic activity. Pure cultures of microorganisms known for their ability to form EA biofilms, such as Geobacter, Desulfuromonas, Shewanella, Geopsychrobacter, Rhodoferrax, Geothrix, etc. and any EA strain known in the prior art may also be used.

Seeding may be carried out when the device is first operated and it may also be renewed during operation to reactivate the device, for example to overcome a reduction in effectiveness or following an operating incident.

The conductive materials of the first and second portions (1), (2), whether identical or different, may be chosen from any conductive material such as, in particular, graphite, carbon, metals such as stainless steel or materials generally used for electrodes, such as iridium-tantalum oxide deposited on titanium. Graphite and stainless steel in particular are preferred.

The person skilled in the art will choose the material that he or she considers most appropriate for treating these media according to the type of medium to be treated and the type of microorganisms. Graphite, carbon, metals, such as stainless steel, or materials specially designed for use as electrodes, such as iridium-tantalum oxides deposited on titanium—known as DSA electrode technology—are known to provide suitable EA biofilm growth. Since known materials appropriate for EA biofilms are extremely diverse, any type of conductive material may be suitable, depending on the composition of the medium to be treated and the type of microorganisms present.

Advantageously, the mass or surface of the materials of the first and second portions (1), (2) may be pre-treated to optimise simultaneously their ability to make the EA biofilm adhere, their electronic conductivity and their ability to promote the growth of highly EA biofilms. It is known that increased roughness promotes the growth of effective EA biofilms. Any change in surface morphology, such as groove formation, sand blasting, micro- or nano-structuring, etc. which has the effect of increasing the available surface for microbial adhesion and encouraging such adhesion will also be advantageous to the system.

The system according to the invention may advantageously be used with a single component, such as a bar made of conductive material, thus producing the short circuit between the two portions of its surface, specifically on the one hand the portion oxidising the organic matter catalysed by an EA biofilm and on the other hand the portion reducing a dissolved or gaseous electron acceptor compound. Any other form suitable for the configuration of the medium to be treated may also be contemplated as long as the oxidation and reduction portions are in short circuit.

Advantageously, the form and structure of the system according to the invention may be designed so as to create the largest possible exchange surfaces for each of the functional zones. In particular, porous structures, such as foams or felts may be mentioned, and any type of structure known in the prior art which has a large specific surface or a high level of empty space. Similarly, forms such as spirals, brushes, dendrites, grids and so on which increase the surface of each component for a given volume may promote its effectiveness. The form may also be designed in correlation with the hydrodynamics of the medium for flowing or stirred liquid environments.

The process according to the invention may also be used generally during the period needed for oxidation. Thus, if oxidation is to take place continuously, the process may also operate continuously. However if oxidation is to be stopped, the process may also be halted, for example by actuating a switch situated between the first and second portions or by removing the system according to the invention from the organic matter to be treated.

The system according to the invention is placed advantageously in the waste or effluent treatment reactor so as to produce a different reaction on each of its two portions. Accordingly, the first portion is placed advantageously in the treatment reactor so that the organic matter oxidation process catalysed by an EA biofilm takes place on its surface. Simultaneously, the second portion must produce the reduction reaction(s) of a species, such as dissolved or gaseous oxygen, contained in a portion of the reactor. The system according to the invention may therefore simply be immersed vertically in an anoxic reactor so that oxidation of the organic matter takes place on the surface of the portion immersed deepest in the reactor, which is rich in organic matter, whereas oxygen reduction takes place on the surface of the second portion placed in the least immersed portion of the reactor, which is richer in oxygen, for example the surface zone.

The reactor may therefore be configured to encourage the formation of a zone which is richer in organic matter to be treated and a zone which is richer in electron acceptor, such as oxygen, nitrates and so on.

This may be produced in particular by:
mere sedimentation in a conventional reactor, where the organic matter forms a sediment at the bottom of the reactor;
by aerating preferably only one portion of the reactor, or by supplying only one portion of the reactor with electron acceptor, such as nitrates, oxygen and so on;
by defining a reactor configuration that favours the formation of these two zones, for example by using two vats coupled in sequence; and/or
by any combination of these techniques and any other technique known by the person skilled in the art which can define preferential zones.

As the system according to the invention comprises two portions, which may be identical or integral, performing different functions, it may be advantageous to optimise the two portions independently to make them as effective as possible. Preferably, the system according to the invention may have a first portion optimised to ensure the adhesion of EA biofilms which oxidise the organic matter and a second portion optimised to carry electrons to a dissolved acceptor compound, such as oxygen, this reaction being catalysed by an EA biofilm or by a catalyst such as platinum.

Optimisation comprises in particular the definition of the form, the location relative to the reactor, the material and/or coating of the surface, the surface morphology, the presence of a catalyst and any other parameter known in the prior art that may improve the two reactions concerned.

The system according to the invention may therefore be added to an existing reactor or may use the portions of a reactor to form a system according to the invention, or it may modify existing portions, with regard to the form, material, coating and so on, to render the system according to the invention more effective.

The process according to the invention may also comprise the prior application of a potential or current to the system to promote the initial development of the system according to the invention. This preliminary stage may take place during the period needed for the system to operate autonomously, which may be a few hours to a few days. This stage may occur in the treatment reactor itself or independently in a reactor and medium specially designed for this purpose.

For batch treatment, it may be advantageous to start the process according to the invention by seeding the medium with microorganisms or complex inocula known in the prior art to form EA biofilms considered suitable for the medium to be treated. Seeding may also take place in an open environment as a technique for starting up the process according to the invention.

In its simplest embodiments, the process according to the invention requires no modification of the reactors used in conventional waste and effluent treatment technologies. The system need only be added to the existing equipment. However, also modifying the existing equipment to implement the principle of the invention on the surface thereof itself is not ruled out.

The system according to the invention is very flexible as it uses as reactive catalysts EA biofilms which form spontaneously from the media to be treated. These EA biofilms can adapt to variations in the quality and composition of the media to be treated.

In its simplest embodiments, the system according to the invention does not comprise a priori any moving part or electrical equipment; it is robust and requires practically no special maintenance.

The system according to the invention may be adapted to any type of waste and effluent, both liquid effluent and solid waste such as compost. To be effective, all that is needed is sufficient contact between the medium to be treated and the system surfaces.

Unlike microbial fuel cells which may be used to intensify effluent treatment processes, the system proposed in the present invention does not divert any energy to produce electricity and thus ensures maximum effectiveness in treating the waste or effluent.

Accordingly and more particularly, the system according to the invention has no electric energy supply, such as a source of voltage or current.

Furthermore, the system according to the invention also differs from cells in that it does not supply electricity. The device according to the invention therefore has no current load and does not require the use of electrochemical reactors having a membrane or any other type of separator to delimit an anodic compartment and a cathodic compartment. Unlike a cell, the device described by the invention operates optimally when all its portions have the same electrochemical potential.

According to another subject-matter, the present invention also relates to a kit for implementing the process according to the invention, said kit comprising:
a first portion (1) made of conductive material;
a second portion (2) made of conductive material;
one or more microorganism(s) (4), (5′) forming an EA film on the surface(s) of the first and possibly the second portions; and
means of producing a short circuit (3) between the first and second portions.

According to a particular embodiment, the kit according to the invention does not comprise a membrane, an electrical energy supply, such as a source of voltage or current, or a current load.

Preferably, the kit according to the invention consists of the above components.

The first and second portions and the microorganism(s) and means of producing a short circuit are defined as above.

Advantageously, the kit is suitable for immersion in a single reactor containing said organic matter to be treated, said microorganisms capable of forming an EA film, and the electron acceptor. It does not comprise a separator component, such as a membrane.

The short-circuiting means may be chosen in particular from any conductive component with the lowest possible resistance, in particular substantially zero, and in any event less than 10 ohms.

The kit according to the invention may also comprise any widely used component, instrument or compound that can improve implementation of the process, in particular that is useful for pre-treatment of the device, possible seeding, system monitoring, maintenance or control. Pre-treatment may comprise a polarisation phase in potentiostatic or intentiostatic mode either by using a conventional electrochemical appliance or by galvanic coupling with an immersed electrode known to provide a constant potential, such as electrodes made of zinc or a magnesium alloy. These instruments form part of the kit. Seeding may be carried out using pure strains or more effectively using consortia of microorganisms taken from EA biofilms, for example specifically cultivated for this purpose. These inocula of EA biofilms form part of the kit. Maintenance may consist of reproducing the pre-treatment phases at predefined time intervals or if a reduction in the effectiveness of the device is detected. Monitoring may be performed in particular by measuring the potential of the device in relation to a reference electrode which forms part of the kit. Control may consist of providing a voltage or intensity of current as described above, with instruments such as a potentiostat, current generator or galvanic coupling forming part of the kit.

### FIGURES

FIG. 1 shows a particular embodiment of the invention in which the system is formed of a single component, such as a bar, of which one end represents the first portion (1) while the other end represents the second portion (2), the interface between the two portions forming the short circuit (3). An EA biofilm (4) forms on the surface of the first portion, while a catalyst (5) is deposited and/or an EA biofilm (5′) is formed on the surface of the second portion (2). The system is immersed in the effluent to be treated (6) contained in a reactor (7).

FIG. 2 shows a variant in which the system is formed of two components, for example two bars, the lower bar representing the first portion (1) and the upper bar representing the second portion (2), connected to one another by a conductor (3). An EA biofilm (4) forms on the surface of the first portion, while a catalyst (5) is deposited and/or an EA biofilm (5′) is formed on the surface of the second portion (2). The system is immersed in the effluent to be treated (6) contained in a reactor (7).

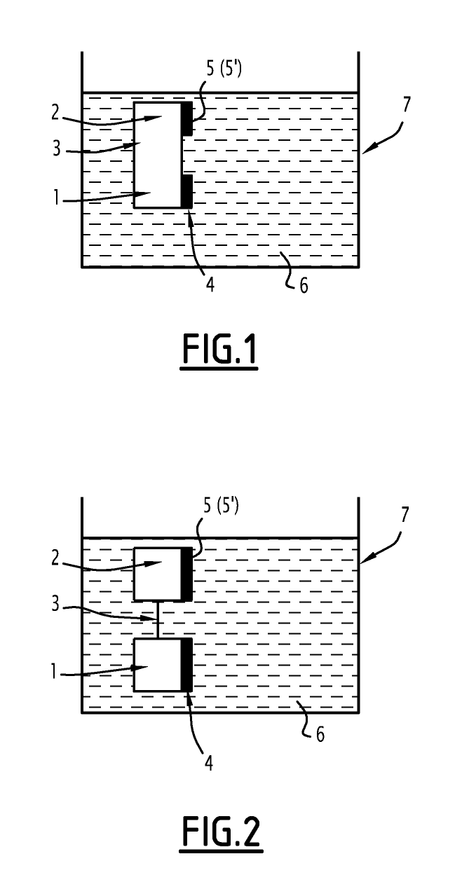

The following example is given as a non-limiting illustration of the present invention.

Three identical bioreactors are made of glass tube 60 mm in diameter and contain 500 ml of seawater. To promote rapid microbial growth, the three reactors are inoculated with the same microbial consortium taken by scratching a surface immersed in the sea. To simulate the presence of a large organic load, known quantities of sodium acetate are added successively and simultaneously to each of the three reactors.

The system according to the invention is formed of 50 cm² of graphite felt connected by a 30 cm titanium rod to a 5 cm² platinum grid which forms the upper portion. Graphite is known to promote the formation of EA biofilms in marine environments and platinum wire is chosen to maximise the electrochemical reduction speeds of the dissolved oxygen. The system according to the invention is placed vertically in the reactor with the platinum zone at the top, in the portion of the reactor which is assumed to be the most aerated.
Bioreactor A is the control bioreactor which monitors natural acetate consumption by the flora introduced into the medium.
The system according to the invention is introduced into bioreactor B.
Bioreactor C is equipped with the same system according to the invention with electrochemical assistance. In this case, potentiostatic assistance is provided by a potentiostat which imposes a fixed potential of −0.1 V/SCE (reference saturated calomel electrode) on the oxidising portion of the system according to the invention, or anode. This case simulates, for example, a pre-treatment phase of the device with electrochemical assistance.

Sodium acetate is added simultaneously to each bioreactor at a final concentration of 1 g per litre. A plurality of successive additions of acetate is made following the total disappearance of the initial load.

Acetate consumption is monitored in each reactor by taking a 1 ml sample and measured by enzymatic analysis using a Boehringer-Mannheim, R-Bioharm kit. Weakening is expressed as a percentage of the load of each successive addition (1 g per litre)

Identical additions of acetate are made simultaneously on day 0 (at the start of the experiment) and on days 5, 10, 15 and 20 in the three bioreactors. The acetate measurements made before the new additions on days 5, 10 and 15 show a weakening of 100% (total acetate consumption) in all three bioreactors. The average speed of acetate weakening is approximately 0.2 g per litre per day (in other words five days to consume the added 1 g per litre).

Significant differences appear after the fourth acetate addition on day 15. The fifth addition is made on day 20, measurements are taken on days 18 and 19 (in other words three and four days after the fourth addition) and on days 23 and 24 (in other words three and four days after the fifth addition). The acetate weakening rates reported in the table below show that:
the control reactor consumes only about 50% of the added acetate after three days; over the same period, the system according to the invention produced a weakening of 61% after the fourth addition and 71% after the fifth addition. These two results show that as the system according to the invention reaches normal operating conditions, performance improves as acetate is added, which is certainly due to the progressive formation of the EA biofilm on the oxidising portion of the system according to the invention.
the system according to the invention assisted by electrochemistry maintains a weakening speed identical to that at the beginning (0.2 g per litre per day). In this case, electrochemical assistance forces faster formation of the EA biofilm, which may constitute a method of pre-treating the device. This permits evaluation of the progression capacity of the system according to the invention.

| | | |
|---|---|---|
| | | C - TE assisted by |
| A - control | B - TE | imposed potential |

4^{th} addition (day 15)

| | | | |
|---|---|---|---|
| Day 18 | 52% | 61% | 79% |
| Day 19 | 71% | 93% | 99% |

5^{th} addition (day 20)

| | | | |
|---|---|---|---|
| Day 23 | 51% | 71% | 80% |
| Day 24 | 65% | 83% | 89% |

1. Process for the oxidation of organic matter comprising the application of a system to said organic matter to be treated comprising
a first portion made of conductive material,
a second portion made of conductive material,
said process comprising simultaneously:
putting the first portion in contact with said organic matter and one or more microorganism(s) forming an electrochemically active (EA) biofilm on the surface of said first portion,
putting said second portion in contact with an electron acceptor in the presence of a catalyst and/or one or more microorganism(s) forming an electrochemically active (EA) biofilm on the surface of said second portion, and
putting said first and second portions in electrical contact via a short circuit.

2. Process according to claim 1 wherein said first and second portions form a single electrically conductive component.

3. Process according to claim 1 wherein said first and second portions are separate and produce a short circuit via an electrical conductor.

4. Process according to claim 1 wherein said electron acceptor is chosen from oxygen, nitrates, nitrites, sulphates and thiosulphate.

5. Process according to claim 1 wherein said catalyst is deposited on the surface of said second portion.

6. Process according to claim 1 wherein the conductive materials of the first and second portions, whether identical or different, are chosen from graphite, carbon, metals such as stainless steel or materials generally used for electrodes.

7. Process according to claim 1 wherein said one or more microorganism(s) form(s) an electrochemically active biofilm on the surface of the second portion.

8. Process according to claim 1 wherein said microorganism(s) and possibly exist(s) spontaneously in the reactive mixture to be treated.

9. Process according to claim 1 comprising a preliminary seeding stage of the reactive mixture to be treated using appropriate microorganism colonies.

10. Process according to claim 1 wherein said first and second portions are respectively formed by the conductive portions of the reactor in which the process is carried out.

11. Process according to claim 1 wherein the system is applied in such a way that the first portion is immersed in a zone of the reactive mixture which is rich in microorganisms capable of forming an EA biofilm.

12. Process according to claim 1 wherein the first portion and/or the second portion is (are) treated beforehand to improve the adhesion and/or growth of the EA biofilm and/or.

13. Process according to claim 12 wherein the pre-treatment comprises groove formation, sand blasting, micro- or nano-structuring.

14. Kit for carrying out the process according to claim 1 comprising:
a first portion made of conductive material;
a second portion made of conductive material;
one or more microorganism(s) capable of forming an EA biofilm; and
means of producing a short circuit between the first and second portions.

15. (canceled)
